(19) United States
(12) Patent Application Publication
(10) Pub. No.: US 2007/0082316 A1
(43) Pub. Date: Apr. 12, 2007

(54) Device for oral care in showers and baths

(76) Inventors: Sam Zhadanov, Brooklyn, NY (US); Eli Zhadanov, Brooklyn, NY (US)

Correspondence Address: Ilya Zborovsky, 6 Schoolhouse Way, Dix Hills, NY, 11746, US

(21) Appl. No.: 11/244,355

(22) Filed: Oct. 6, 2005

(51) Int. Cl. A61C 17/02; A61C 1/12

(52) U.S. Cl. 433/80; 433/82

(57) ABSTRACT

A device for oral care in showers and baths has a water issuing member, a structure forming a throughoing passage connectable to a water source and supplying water to the water issuing member, a structure for regulating a parameter of the water supplied through the throughgoing passage to the water issuing element to allow a flow of water or to interrupt the flow of water, means forming a chamber fillable with a medium to be introduced into water, and a connecting element for connecting the throughgoing passage to the water source through a hose, so that water flows by a self-flow from the water source without pump, intermediate vessels and the like through the hose and then through the throughgoinog passage to issue from the water issuing member.

### BACKGROUND OF THE INVENTION

The present invention relates to devices for oral care, in particular for deep cleaning mouth care, in showers and baths, for household use.

Devices for oral care as a rule have a compressor operating from an electric grid or from an accumulator. These devices have great dimensions, they operate in a short mode, and require separate procedures. It is believed to be advisable to improve the above mentioned devices.

### SUMMARY OF THE INVENTION

It is therefore an object of the present invention to provide a dental care device, which avoids the disadvantages of the prior art.

More particularly, it is an object of the present invention to provide a oral care device for showers and bath which is powered in a simple manner, can be adjusted in many ways, provides automatic preparation of a required medium, is easily connectable to a water system, and can be used during water procedures.

It is also an object of the present invention to provide the oral care device which has a small size and therefore does not require a special storage, so that it can be placed on shelves in shower cabins, etc.

In keeping with these objects and with others which will become apparent hereinafter, one feature of the present invention resides, briefly stated, in a device for oral care in showers and baths, comprising a water issuing member; means forming a throughoing passage connectable to a water source and supplying water to said water issuing member; means for regulating a parameter of the water supplied through said throughgoing passage to said water issuing element to allow a flow of water or to interrupt the flow of water; and connecting means for connecting said means forming said throughgoing passage to the water source through a hose, so that water flows by a self-flow from the water source without pump, intermediate vessels and the like through the hose and then through said throughgoinog passage to issue from said water issuing member.

When the oral care device is designed in accordance with the present invention, it eliminates the disadvantages of the prior art and provides above mentioned highly advantageous results.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a cross-section of a device in accordance with the present invention;

FIG. 2 is a view showing a cross-section of a housing of the inventive device;

FIG. 3 is an end view of the housing of the inventive device;

FIG. 4 is a view showing a cross-section of the plunger of the inventive device;

FIG. 5 is a view showing an end view of the plunger of the inventive device;

FIG. 6 is a view showing a cross-section of a jet tip of the inventive device;

FIG. 7 is a view showing a cross-section of a fitting of the inventive device;

FIG. 8 is a view showing a cross-section of a tubular member of the inventive device;

FIGS. 9 and 10 are two views of a valve of the inventive device;

FIG. 11 is a view showing a cross-section of a plug of the inventive device;

FIGS. 12 and 13 are two views showing a tooth brush provided in the inventive device; and

FIGS. 14 and 15 are views showing an inventive system, in which the inventive device is connected to a faucet and to a shower arm correspondingly.

### DESCRIPTION OF THE PREFERRED EMBODIMENTS

A device for oral care for showers and baths in accordance with the present invention has a housing which is identified with reference numeral 1. A plunger 2 is located inside the housing and has a sealing ring 3 and a fixing nut 4. A rod 5 is located inside the plunger.

A plug 6 is arranged in a front part of the housing and has sealing rings 7, 8, 9, and a gasket 10. A valve 11 is located inside the plug. A fitting 12 is screwed into the plug. A jet tip 13 is screwed into the fitting 12 and has a sealing ring 14. The jet tip 13 is removable and interchangeable. For example, the device can be provided with several removable jet tips, each for a respective member of a family.

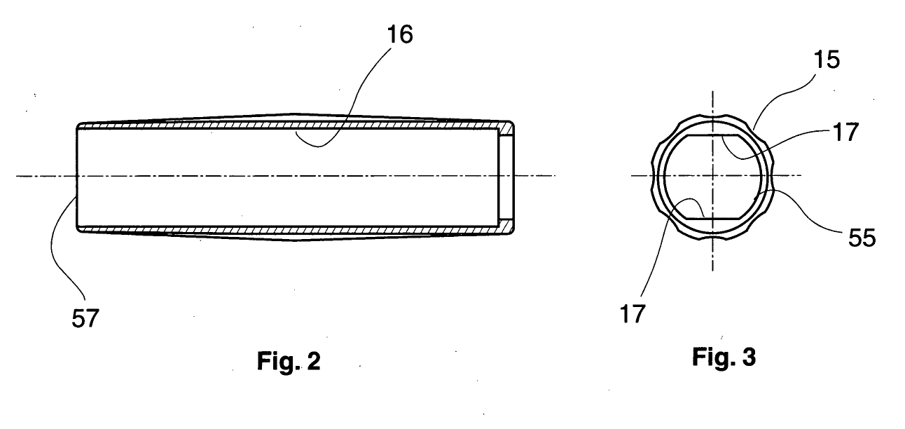

The housing 1 which is shown in FIGS. 2 and 3 is formed as a handle with longitudinal grooves 15 on its outer surface, to make comfortable its holding during the operation. It has an inner opening 16 with a cylindrical shape. One end 55 of the opening has two flats 17. Another end 57 of the opening is cylindrical.

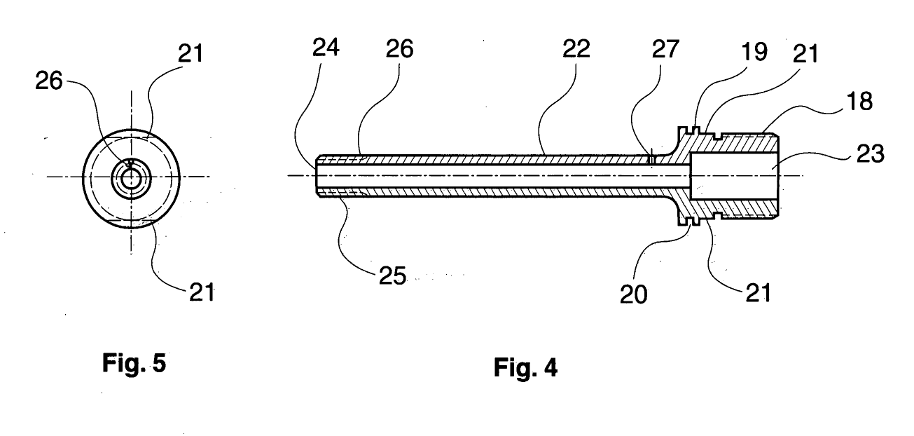

The plunger 2 shown in FIGS. 4 and 5 has a threaded part 18, a piston part 19 with a groove 20, and two flats 21. The piston part is formed of one piece with a hollow plunger member 22 with openings 23 and 24. In a front part the plunger 2 has a thread 25 and a longitudinal groove 26. An opening 27 is provided in a rear part of the plunger.

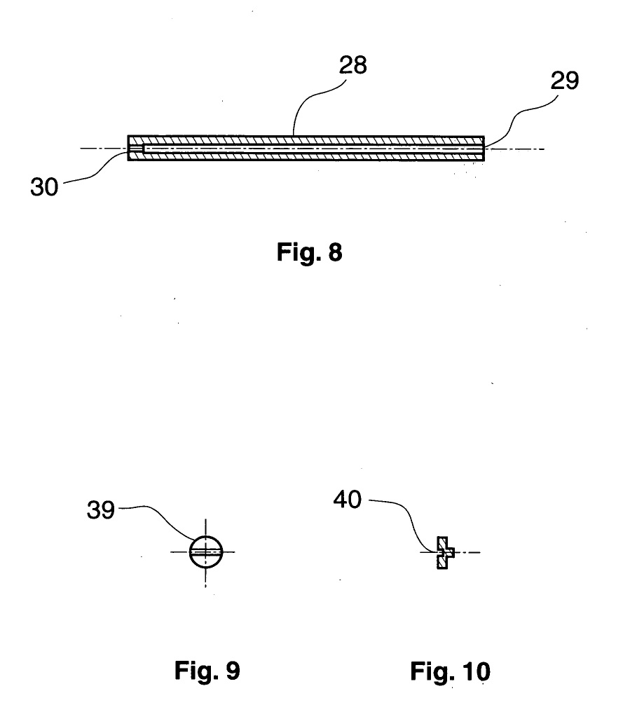

A tubular member 5 shown in FIG. 8 is substantially cylindrical and has a surface 28 which corresponds to the opening of the plunger 24.with a sliding fit. It also has inner openings 29 and 30.

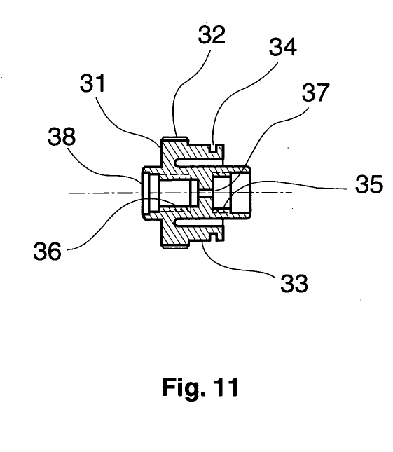

The plug 6 shown in FIG. 11 has a flange 31 with a knurling 32 on its periphery, a cylindrical part 33 with a groove 34, two threaded openings 35 and 36 connected with one another by an opening 37, and a groove 38 for a sealing ring.

The valve 11 which is shown in FIGS. 9 and 10 includes a disc 39 with a central laterally open slot 10. The fitting 12 shown in FIG. 7 has a flange 41 with a knurling 42 on its periphery, a hub 43 with a groove 58, outer thread 44, and an inner opening 45. At the end side, the fitting has a threaded opening 46 and an annular groove 47.

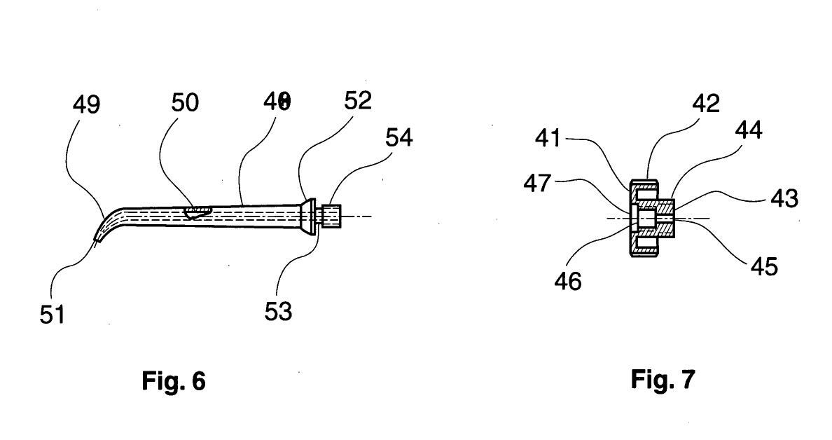

The jet tip 13 shown in FIG. 6 is formed as a conical pipe 48 which is bent and has outlet part 49. It has an opening 50 which merges into a microopening 51 of a very small diameter. The microopening 51 is significantly smaller than the inlet opening of the plunger 2. In the rear part, the jet tip has a hub 52 with a groove 53 and a thread 54.

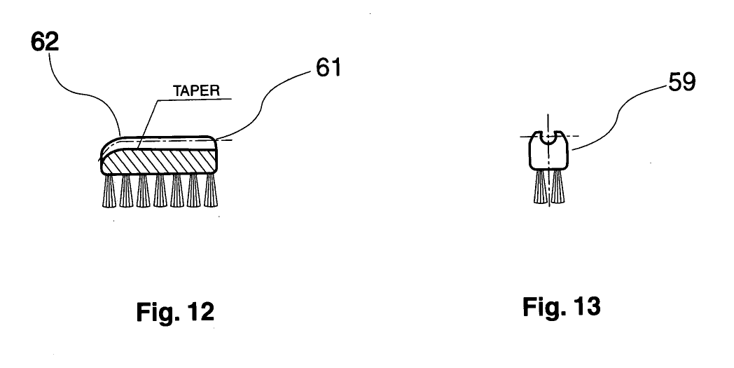

FIGS. 12 and 13 show a tooth brush 58 having a body 59 with bristles 60 and a rounded tapered slot 61 which ends in a curved slot 62. The brush can be attached to the jet tip removably and interchangeably by snapping due to its elasticity and can be used with water or without water anywhere any time.

The device in accordance with the present invention operates in the following manner.

The device is connected to a water supply system with its threaded part 18 directly or through an intermediate quick-connect element. The housing 1 which is assembled on the plunger 2 through the opening 55 with the flats 17 and fixed by the nut 4 is hermetically closed with the sealing ring 3 so as to form a chamber 56. At the opposite side, the chamber 56 is closed with the plug 6 which is screwed on the plunger 22 via a connection of the opening 35 with the plunger element 22 and is sealed by the sealing ring 7. The chamber 56 is provided for medical solutions both in a liquid state and in form of a granules which can be dissolved in water, and supplied on a surface to be treated.

The sealing ring 9 and the valve 1 shown in FIGS. 9 and 10 are introduced in the threaded openings 36 of the plug shown in FIG. 11, and the fitting 12 shown in FIG. 7 is screwed in. Thereafter the jet tip 13 shown in FIG. 6 is screwed into the fitting, with the sealing ring 14 closing the groove 47.

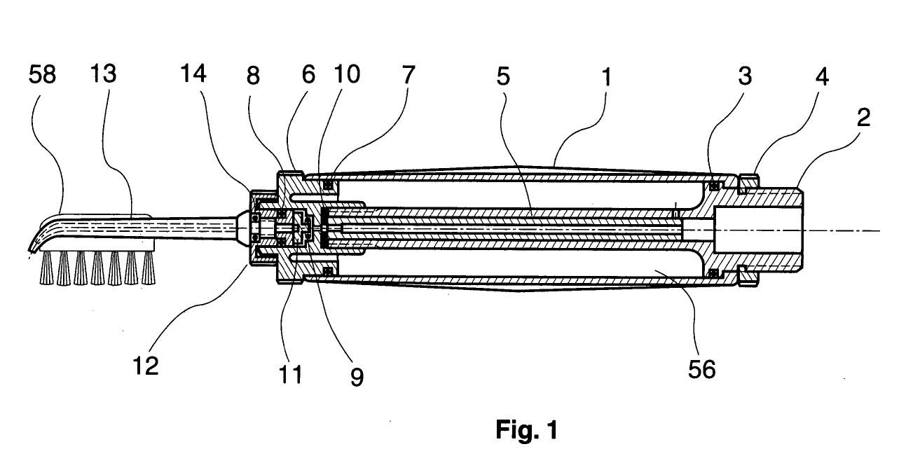

Supply of water is performed through a system of openings 23 of the plunger 2, then through the openings 29 and 30 of the tubular member 5 shown in FIG. 9, into the opening 37 shown in FIG. 11 and the opening valve 11 shown in FIGS. 9, 1 O through the groove 40 into the opening 50 of the jet tip 13, and then through the outlet opening 51.

In the outlet opening 51 the jet is formed which under pressure is supplied on a surface to be treated. The pressure of the jet can be regulated from zero to maximum by opening of the valve, by means of turning of the fitting 12 with the knurling 42. In the position shown in FIG. 1 the fitting 12 is completely screwed in and the valve 11 is pressed against the seal 9. When the fitting 12 is unscrewed by the user to move to the left in FIG. 1, the water pressure pushes the valve 11 to the left and water flows between the seal 9 and the valve 11, through the groove 40 and then through the openings of the fitting 12. The water supply quantity and pressure depends on a degree of unscrewing of the fitting 12.

The chamber 56 is filled with a treatment medium, for example a medication, from the side 57 of the housing 1 shown FIG. 2, and closed by the plug 6. When the plug is completely closed by screwing of the threaded opening 35 shown in FIG. 11 and the thread 25 with one another the sealing ring 8 closes the groove 26 and stops a flow of the medium from the chamber 56. The closing of the plug moves the pipe 5 to an extreme position shown in FIG. 1 so as to close also the opening 27 shown in FIG. 4, through which a flow of water under pressure in the opening 23 can be pumped into the chamber 56 when the opening 27 is open. As a result the simultaneous overlapping of the inlet opening 27 and outlet opening 26 takes place, so that the supply of medium into a water flow is interrupted. The opening of the opening 27 and the groove 26 is performed by unscrewing of the plugs and displacing the tubular member 5 under the action of water.

When both the opening 27 and the groove 26 are open, water flows through the opening 27 into the chamber 56 and by its pressure expels the medium from the chamber, which medium then flows through the groove 26 into the openings of the plug 6, to be mixed with water and then supplied to the jet tip. The quantity of the medium introduced into the water is regulated by the degree of opening of the opening 27 and the groove 26 at the inlet end and the outlet end of the chamber.

Therefore, the device in accordance with the present invention actually has two independent systems of regulations, by which allow to regulate continuously a flow of water from zero to a maximum and a flow of additional medium also continuously from zero to a maximum.

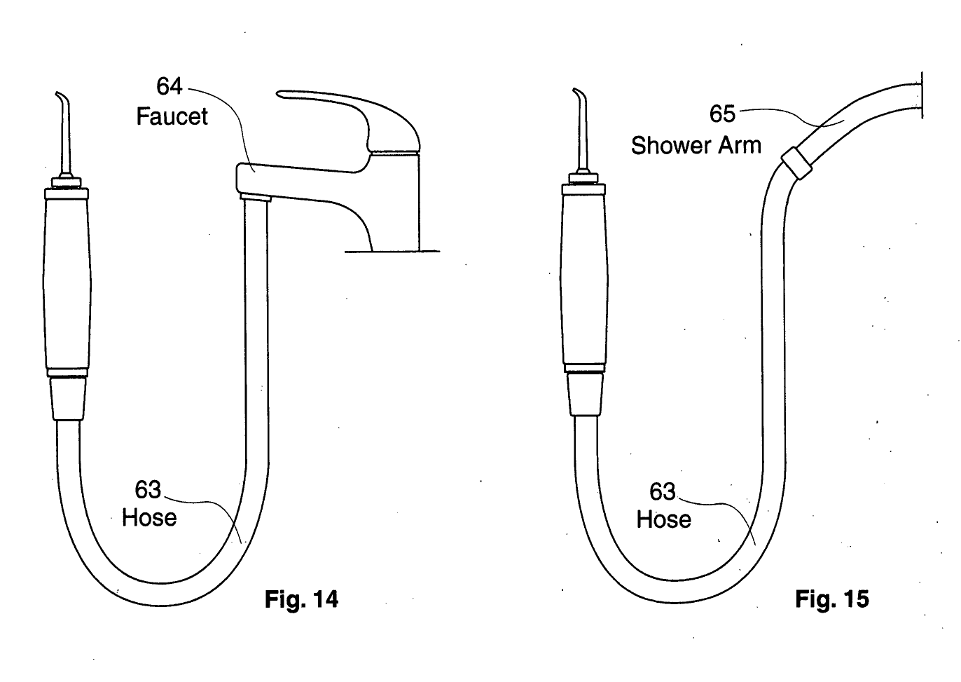

As shown in FIGS. 14 and 15 the device is connectable by a hose 63 to a water source 64 or 65, formed as a faucet or a shower arm. The system does not have any pumps, any intermediate vessels, any power generating devices. Water from the water source 64, 65 flows by a self-flow through the hose 63 into the device, through the latter, and then issues from the jet tip in a narrow, intense jet.

Toothbrushing or other oral care procedures can be performed with water, without water, with water into which additional substances are introduced.

It will be understood that each of the elements described above, or two or more together, may also find a useful application in other types of constructions differing from the types described above.

While the invention has been illustrated and described as embodied in a device for dental care, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A device for oral care in showers and baths, comprising a water issuing member; means forming a throughoing passage connectable to a water source and supplying water to said water issuing member; means for regulating a parameter of the water supplied through said throughgoing passage to said water issuing element to allow a flow of water or to interrupt the flow of water; and connecting means for connecting said means forming said throughgoing passage to the water source through a hose, so that water flows by a self-flow from the water source without pump, intermediate vessels and the like through the hose and then through said throughgoinog passage to issue from said water issuing member.

2. A device as defined in claim 1, wherein said means for regulating a parameter of water supplied to said water issuing element include a valve member and an actuating member which presses said valve member against a seal to interrupt a flow of water and which is displaceable to allow said valve member to move away from said seal under the action of water to adjust a throughflow of water through said valve.

3. A device as defined in claim 1; and further comprising means forming a chamber fillable with a medium to be introduced into water; means for connecting said chamber with said throughgoing passage so that water from said throughgoing passage can be supplied into said chamber to expel the medium from said chamber, which expelled medium is then supplied into the throughgoing passage to be mixed with water; and means for regulating a supply of water.

4. A device as defined in claim 3; and further comprising means for regulating a supply of water into said chamber and a supply of the medium from said chamber so as to continuously adjust a quantity of the medium mixed with water.

5. A device as defined in claim 4, wherein said means for regulating a flow of water into said chamber and a flow of the medium from said chamber include a first opening located at an inlet side of said chamber and a second opening located at an outlet side of said chamber, and an adjusting member operative for closing of both said openings at said inlet side and said outlet side of said chamber for interrupting the flow and for releasing said openings at said inlet side and said outlet side for continuously regulating the quantity of water supplied into said chamber and a quantity of the medium supplied from said chamber.

6. A device as defined in claim 4, wherein said means for regulating a parameter of water and said means for regulating a supply of the medium into water are separate means which are actuatable independently from one another.

7. A device as defined in claim 1; and further comprising a tooth brush arranged so that it can operate with a water flowing through it and without the water supply.

8. A device as defined in claim 7, wherein said tooth brush is removably and interchangeably arranged on said water issuing element.

9. A device as defined in claim 7, wherein said tooth brush is attachable to said water issuing element by snapping.

10. A device as defined in claim 1, wherein said water issuing element is formed as a jet tip which has an outlet opening of a smaller size than an inlet opening of said means forming said throughgoing passage and is arranged removably and interchangeably.

11. A system for oral care in showers and bath, comprising a water source formed as a water pipe; a hose connected to said water pipe; and device for oral care in showers and baths, said device including a water issuing member, means forming a throughoing passage connectable to a water source and supplying water to said water issuing member, means for regulating a parameter of the water supplied through said throughgoing passage to said water issuing element to allow a flow of water or to interrupt the flow of water; and connecting means for connecting said means forming said throughgoing passage to the water source through a hose, so that water flows by a self-flow from the water source without pump, intermediate vessels and the like through the hose and then through said throughgoinog passage to issue from said water issuing member.
